(19) United States
(12) Patent Application Publication
(10) Pub. No.: US 2013/0154957 A1
(43) Pub. Date: Jun. 20, 2013

(54) SNAP TO CENTER USER INTERFACE NAVIGATION

(71) Applicants: Howard Locker, Cary, NC (US); Daryl Cromer, Cary, NC (US); Steven R. Perrin, Raleigh, NC (US)

(72) Inventors: Howard Locker, Cary, NC (US); Daryl Cromer, Cary, NC (US); Steven R. Perrin, Raleigh, NC (US)

(73) Assignee: LENOVO (SINGAPORE) PTE. LTD., Singapore (SG)

(21) Appl. No.: 13/331,664

(22) Filed: Dec. 20, 2011

(51) Int. Cl. G06F 3/041; G09G 5/00

(52) U.S. Cl. 345/173; 345/156

(57) ABSTRACT

Systems, methods and products directed toward snap to center user interface navigation are presented herein. One aspect includes executing an ultra-mobile user interface displayed on a display device accessible by an information handling device, the ultra-mobile user interface being comprised of one or more landing zones; ascertaining a user selected position within the ultra-mobile user interface based on user input communicated through one or more input devices operatively coupled with the information handling device; and selecting one of the one or more landing zones determined to be in closest proximity to the user selected position. Other embodiments are described herein.

### BACKGROUND

The presence of mobile devices, such as smartphones and tablet computing devices, in the overall computing device marketplace continues to experience accelerating growth. One reason is the steady increase in computing power and functionality with each new mobile device release. As a result, applications and operating systems are being designed for mobile computing devices without regard for more conventional form factors and input devices. Instead, these applications are being optimized for mobile device operation, for example, by being configured to enhance finger touch screen gesturing and accommodate a smaller screen size.

### BRIEF SUMMARY

In summary, one aspect provides an information handling device comprising: one or more processors; a memory storing program instructions accessible by the one or more processors; a display device accessible by the one or more processors; wherein, responsive to execution of program instructions accessible by the one or more processors, the one or more processors are configured to: execute an ultra-mobile user interface displayed on the display device, the ultra-mobile user interface being comprised of one or more landing zones; ascertain a user selected position within the ultra-mobile user interface based on user input communicated through one or more input devices operatively coupled with the information handling device; and select one of the one or more landing zones determined to be in closest proximity to the user selected position.

Another aspect provides a method comprising: executing an ultra-mobile user interface displayed on a display device accessible by an information handling device, the ultra-mobile user interface being comprised of one or more landing zones; ascertaining a user selected position within the ultra-mobile user interface based on user input communicated through one or more input devices operatively coupled with the information handling device; and selecting one of the one or more landing zones determined to be in closest proximity to the user selected position.

A further aspect provides a program product comprising: a storage medium having program code embodied therewith, the program code comprising: program code configured to execute an ultra-mobile user interface displayed on a display device accessible by an information handling device, the ultra-mobile user interface being comprised of one or more landing zones; program code configured to ascertain a user selected position within the ultra-mobile user interface based on user input communicated through one or more input devices operatively coupled with the information handling device; and program code configured to select one of the one or more landing zones determined to be in closest proximity to the user selected position.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 provides an example user interface for an ultra-mobile ecosystem.

FIG. 2 provides an example of snap navigation according to an embodiment.

FIG. 3 provides an example snap navigation process based on direction of movement on a pointing device configured according to an embodiment.

FIG. 4 provides an example of handling user movement according to a policy configured according to an embodiment.

FIG. 5 is provides another example process of snap navigation according to an embodiment.

FIG. 6 provides an example snap navigation process based on area of contact on a pointing device configured according to an embodiment.

FIG. 7 provides an example cloud-computing configuration utilizing an embodiment.

FIG. 8 illustrates an example circuitry of an information handling device system.

FIG. 9 illustrates another example circuitry of an information handling device system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

Mobile information handling devices continue to experience incredible growth in the computing device marketplace, especially ultra-mobile, hand-held devices. Prominent examples include ultra-mobile devices operating under the Android®, iOS®, and Windows® 8 Metro ecosystems. Android® is a registered trademark of Google Inc. iOS® is a registered trademark of Cisco Technology, Inc. and is used by Apple Inc. under license. Windows® is a registered trademark of Microsoft Corporation in the United States and other countries. As such, users are spending more time working with these ultra-mobile devices and, as a result, experiencing an increased comfort level interacting with ultra-mobile form factors and input methods.

Conventional computing device form factors include desktop personal computers (PCs) and laptop computers, particularly laptop computers having certain dimensions (e.g., a screen size greater than 10 inches, with a majority between 14 and 15.4 inches) and structure. These devices operate through one or more conventional input/output devices, such as a keyboard, mouse, touchpad (physical or emulated), larger display devices, or some combination thereof. In general, ultra-mobile information handling device form factors are comprised of a much smaller and lighter form factors than conventional computing devices, for example, form factors capable of “hand-held” operation. Exemplary devices include smartphones, tablet or slate computing devices, personal digital assistant (PDA) devices, and e-readers. Ultra-mobile information handling device ecosystems may be configured to operate through a touch screen, restricted keyboard (e.g., smaller keyboard comprised of small keys in close proximity to one another), trackball, emulated input devices, such as emulated touchpads or keyboards, or some combination thereof.

The increased presence of ultra-mobile information handling devices has resulted in a growing number of applications and operating systems developed specifically for ultra-mobile ecosystems. Compared to applications and operating systems developed for conventional computing device form factors, products developed for ultra-mobile ecosystems may be optimized for ultra-mobile input methods, such as touch screen input, and finger touch screen input in particular. For example, applications optimized for finger touch screen ultra-mobile ecosystems may be comprised of large landing zones that facilitate finger selection input. Additional characteristics of ultra-mobile ecosystems may include large icons and an absence of menus, or menus with limited information, displayed at a low resolution.

It is less efficient to perform certain functions, for example, editing a spreadsheet document, and to experience prolonged, intensive working sessions with an ultra-mobile ecosystem, particularly an ultra-mobile ecosystem configured for finger touch screen input as the main form of user input. Such work may be better performed on a conventional computing device form factor providing a more immersive experience through a larger display surface, hands free operation, and conventional input devices, such as a full keyboard, mouse, trackpoint, or touchpad.

According to existing technology, a user working in an ultra-mobile ecosystem and wanting to switch to an immersive experience would have two alternatives. In the first alternative, the user would have to transfer data and files to a conventional computing device and work using the conventional computing device file formats and applications. The first alternative does not provide for a very efficient transfer between work environments, as the user would have to continually transfer files and switch user experiences each time he moved between devices. In the second alternative, the user may connect the ultra-mobile device to one or more conventional input/output devices, such as a larger display, full keyboard, mouse, touchpad, docking station, or some combination thereof. However, the second alternative does not provide for an optimal working environment, as applications developed for ultra-mobile ecosystems are not designed to be efficient with conventional input/output devices.

Embodiments provide a user experience for efficiently interacting with an information handling device environment optimized for ultra-mobile ecosystem operation through one or more conventional computing devices and/or conventional input/output devices. In a non-limiting example, certain embodiments provide a user experience for efficiently interacting with an information handling device environment optimized for touch screen operation through one or more conventional (i.e., non-touch screen) input devices. A first illustrative and non-restrictive example provides for operating a user interface developed and optimized for the touch screen input device of a smartphone using a laptop computer having a touchpad, keyboard, and mouse input devices. In a second illustrative and non-restrictive example, a user may efficiently interact with a user interface optimized for touch screen input using an emulated input device, such as an emulated touchpad, on an ultra-mobile information handling device (e.g., tablet computing device).

According to embodiments, an information handling device may include, but is not limited to, a smartphone, tablet or slate computing device, personal digital assistant (PDA), e-reader, or any other device capable of carrying out aspects of the invention as provided herein. An ultra-mobile device optimized environment may include any device operating environment, including operating systems and applications, capable of functioning within an ultra-mobile ecosystem. For example, ultra-mobile device optimized environments may be optimized for accepting user input through a touch screen, finger touch screen, restricted keyboard and pointing device, or some combination thereof. Non-limiting examples include the Android®, Apple® iOS®, and Windows® 8 mobile operating systems and applications developed therefor.

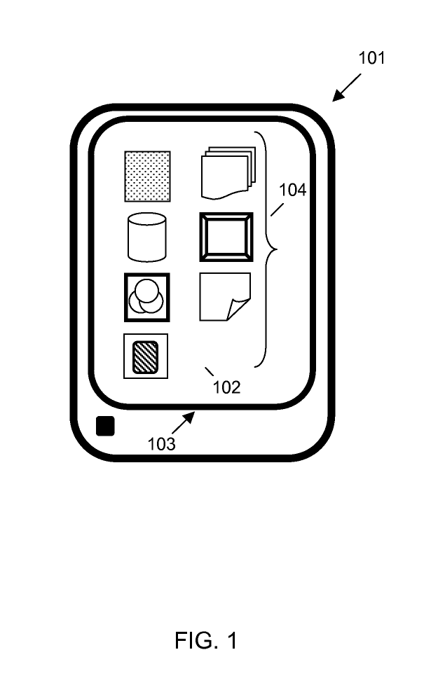

In general, interfaces optimized for ultra-mobile ecosystems may be comprised of large touch landing zones or tiles, which are essentially active areas on the touch screen receptive to touch gestures. FIG. 1 provides an example user interface optimized for an ultra-mobile ecosystem. The user interface 102 is operating on an ultra-mobile information handling device 101, which in FIG. 1 is a smartphone having a finger touch screen 103. The interface 102 is comprised of multiple landing zones 104 in the form of application or function icons. A user touch gesture selecting one of the landing zones 104, for example, tapping a finger on the touch screen 103 in the area of the landing zone, invokes execution of the corresponding application or function. Selection of a non-landing zone (i.e., an inactive area on the interface) area does not invoke any application or function.

Laptop computer form factors, such as the ThinkPad® series of personal computers sold by Lenovo (US) Inc. of Morrisville, N.C., may consist of touchpad, keyboard, trackpoint, and mouse input devices and a non-touch screen display. ThinkPad® is a registered trademark of Lenovo (Singapore) Pte. Ltd. in the United States, other countries, or both. In general, the user interface of a computing device utilizing such input devices maintains a cursor or active area on the user interface. When a user touches the touchpad with his finger, the cursor or active area is selected wherever it is on the user interface and is moved in the direction of finger movement, if possible. Although the term touchpad is utilized herein, embodiments are not so limited, as any pointing device capable of carrying out the invention is contemplated herein, including a trackpad, mouse, trackball, pointing stick, and any input device utilized to translate user gestures into positions on an information handling device user interface.

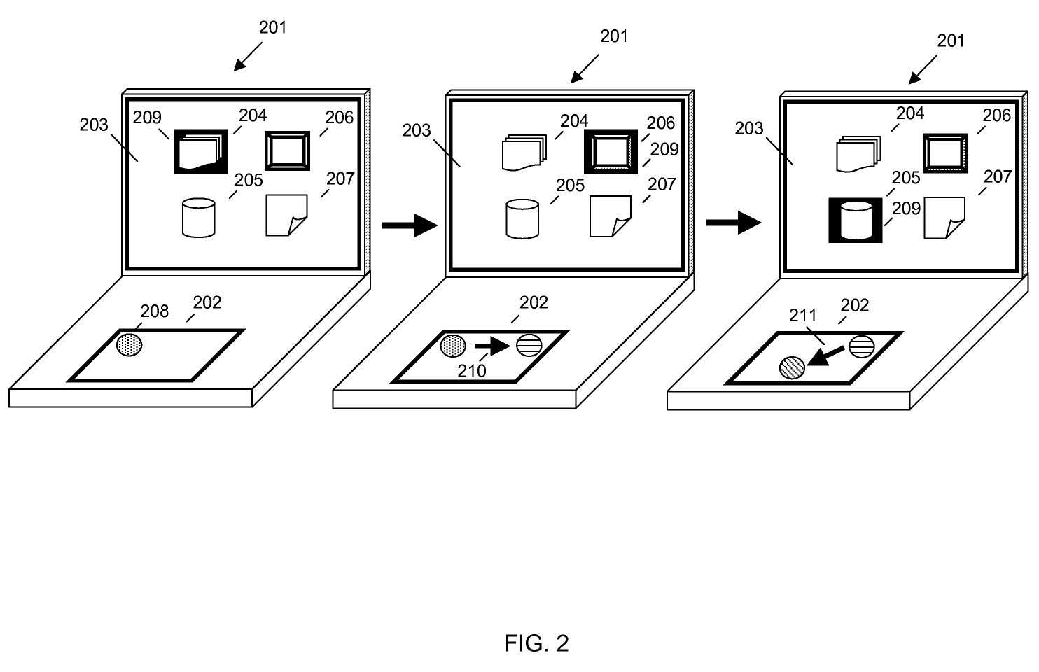

Embodiments provide processes for navigating a user interface optimized for an ultra-mobile information handling device ecosystem utilizing one or more conventional input/output devices. According to embodiments, a snap navigation process may operate to optimize pointing device gesture selection and navigating among user interface landing zones. Referring to FIG. 2, therein is provided an example of snap navigation according to an embodiment. In FIG. 2, an information handling device 201 is provided having a touchpad 202 input device and a user interface 203 displaying four landing zones 204-207. According to embodiments, the user interface 203 is aware of the location of each user interface landing zone within the user interface and also detects and tracks user gestures. In the non-limiting example illustrated in FIG. 2, the information handling device 201 is a laptop computer displaying a user interface 203 for an application optimized for ultra-mobile ecosystem touch screen navigation.

In FIG. 2, a user touches the touchpad 202 and the user interface 203 determines the closest landing zone 204-207 to the touch location 208. The user interface selects or places a cursor 209, or other indicator specifying the selected area on the screen, on the corresponding landing zone 204-207, which in the example of FIG. 2, is landing zone 1 204. The user then drags his finger from left to right 210 across the touchpad 202. The user interface 203 detects the direction of motion and determines the center of the closest landing zone 204-207 in the direction of finger movement 210. In this example, the closest landing zone is landing zone 3 206. The cursor 209 jumps from landing zone 1 204 and snaps to landing zone 3 206. As such, the user does not have to navigate the inactive area between landing zones, as the user interface determines the landing zone the user intends to select based on the direction of user input movement and snaps the cursor to that area of the user interface. Thus, the user input motion may emulate selection of landing zones on a touch screen interface.

As shown in FIG. 2, with landing zone 3 206 now selected, the user drags his finger diagonally down the touchpad from right to left 211. The user interface 203 detects the direction of motion and determines the center of the closest landing zone 204-207 in the new direction of finger movement 211. In this example, the closest landing zone is landing zone 2 205. The cursor 208 jumps from landing zone 3 206 and snaps to landing zone 2 205.

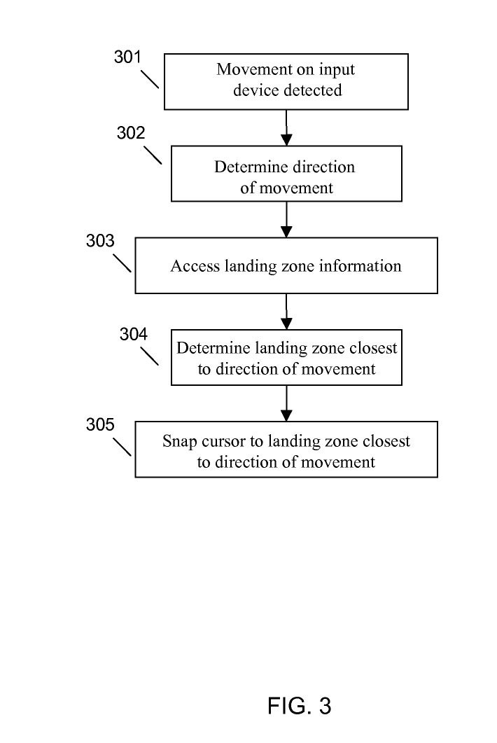

In FIG. 3, therein is provided an example snap navigation process based on direction of movement on a pointing device configured according to an embodiment. The information handling device user interface detects movement on an operably connected input device 301 and determines the direction of the movement 302. The user interface accesses information pertaining to the location of landing zones on the user interface 303 and determines the closest landing zone in the direction of the user movement on the pointing device 304. The user interface snaps the cursor to the closest landing zone in the direction of user movement 305.

Snap navigation may be configured according to embodiments to handle different user gestures and movement according to one or more policies. An illustrative and non-restrictive example provides that any detected movement away from a selected landing zone may cause the cursor to jump from the selected landing zone to the closest non-selected landing zone in the direction of movement. Another non-restrictive example provides that user movement must be greater than a certain distance threshold (e.g., pixels or lines) or distance ratio (e.g., a certain distance percentage away from one landing zone and toward another landing zone) before the cursor may jump and select a particular landing zone. A policy configured according to an embodiment may be based on user input communicated through an input device, cursor activity within the user interface, or some combination thereof.

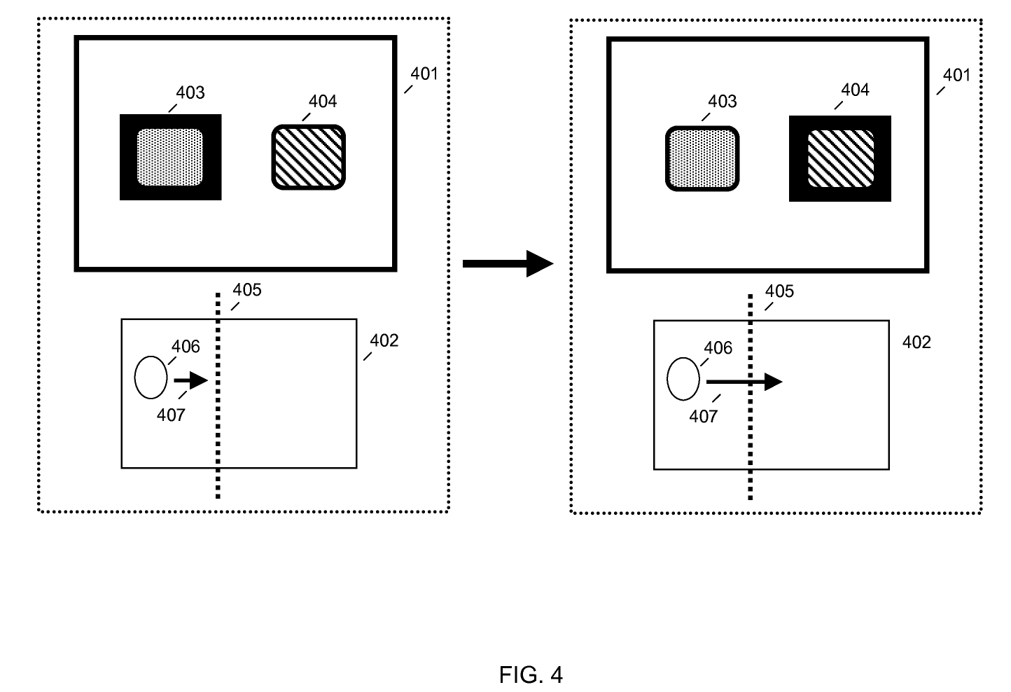

FIG. 4 provides an example of handling user movement according to a policy configured according to an embodiment. FIG. 4 shows a user interface 401 operably coupled to a touchpad input device 402. The user interface 401 has two landing zones 403, 404. According to the embodiment depicted in FIG. 4, the user interface 401 must detect movement on the touchpad 402 within a certain distance of a landing zone before it may jump and snap the cursor to that landing zone. In the example shown in FIG. 4, landing zone 1 403 is selected. If the user moves his finger 406 on the touchpad 402 in the direction of landing zone 2 404, landing zone 2 404 may not be selected unless the user interface detects movement 407 beyond a certain distance 405 away from landing zone 1 403 and toward landing zone 2 404. Embodiments provide that the distance that invokes cursor jumping and snapping may be a function of the motion distance away from a selected landing zone, the motion distance toward a non-selected landing zone, or some combination thereof.

Due to the nature of human movement, user gestures communicated through a pointing device do not consist of precise straight lines. Embodiments may be configured to determine the direction of movement using one or more straight line approximations of the actual movement communicated through a pointing device. According to embodiments, a best fit line (otherwise known as a “line of best fit” or “trend” line) may be used to determine the direction of motion. The best fit line may be extended along the screen in the direction of motion and the user interface may be configured to snap the cursor to the tile or landing zone closest to the best fit line. According to embodiments, a constant calculation may be performed based on the center of the line and the center of each landing zone, facilitating cursor jumping and snapping to the landing zone determined to be closest to the center line in the direction of movement at any point in time.

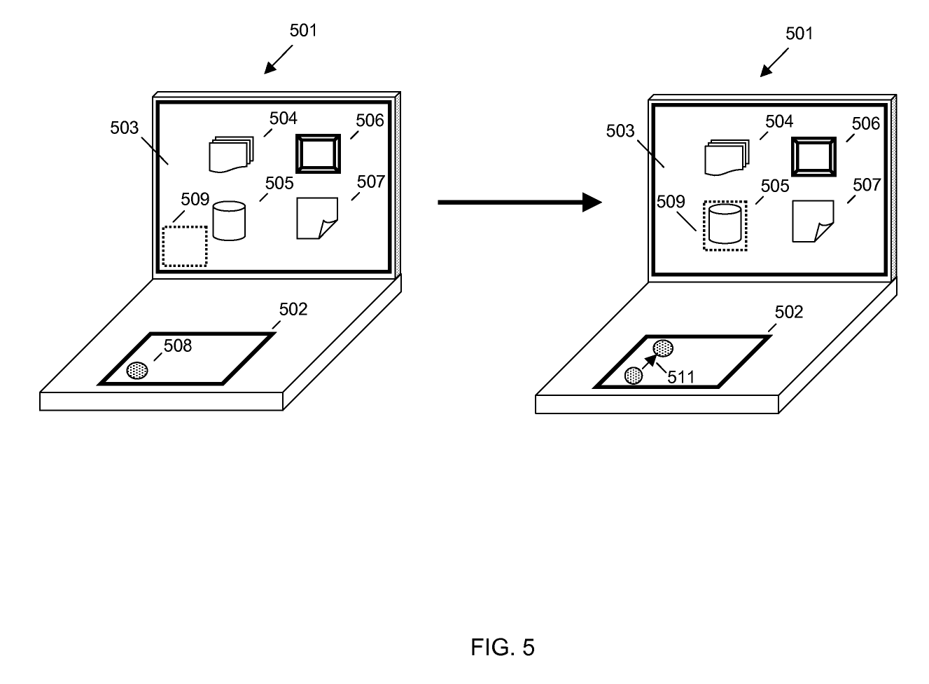

Referring to FIG. 5, therein is provided another example process of snap navigation according to an embodiment. An information handling device 501 is provided in FIG. 5 having a touchpad 502 input device and a user interface 503 displaying four landing zones 504-507. According to embodiments, the user interface 503 is aware of the location of each landing zone 504-507 within the user interface 503 and also detects and tracks user gestures. In the non-limiting example illustrated in FIG. 5, the information handling device 501 is a laptop computer running an application optimized for ultra-mobile ecosystem touch screen navigation.

In the example embodiment depicted in FIG. 5, the touchpad 502 is mapped to the user interface 503 such that each location on the touchpad corresponds to a location on the user interface. For example, the center of the touchpad corresponds to the center of the user interface, the bottom center of the touchpad to the bottom center of the user interface, the top center of the touchpad to the top center of the user interface, and so on such that the entire area of the touchpad is mapped to the user interface.

If the touchpad and the user interface have the same dimensions, the mapping may be a one-to-one mapping; otherwise, alternative mapping methods may be utilized. According to an embodiment, mapping may be performed using linear translate, for example, using a linear multiplier to map the touchpad area to the user interface area. As indicated hereinabove, certain embodiments may utilize pointing devices such as a mouse, which do not have user gesture surface area dimensions but, nonetheless, have position information that may be tracked by a user interface. According to embodiments, the user interface may map pointing devices lacking a surface area to correspond with the area of the user interface. A non-limiting example provides that the user interface takes a current position of the pointing device as being at the center of the user interface and tracks motion in relation to that position, either directly or using a ratio (e.g., a centimeter of movement using a mouse equals a millimeter of movement on the user interface).

When a user selects a location 508 on the touchpad 502, an indicator 509 appears on the user interface 503 indicating the selected location on the user interface 503. According to embodiments, a user may then make a selection by lifting their finger or by some other gesture indicating selection (e.g., tapping the touchpad with a second finger, pressing a selector switch, etc.). In addition, embodiments provide that a user may maintain contact with the touchpad 502 and move their finger on the touchpad 502 to cause the cursor to jump and snap to a different landing zone. Certain embodiments provide that the cursor may automatically snap to the landing zone closest to the point of contact with the touchpad (e.g., tapping or pressing a finger on the touchpad). In other embodiments, the cursor may automatically snap to a landing zone if the user interface area corresponding to the point of touchpad contact is within a certain distance of a landing zone, for example, to limit or avert unintended selections.

As shown in FIG. 5, the user initially contacts 508 the touchpad 502 and the indicator 509 is in an inactive area of the user interface. The user moves his finger 511 on the touchpad 502 and the indicator 509 moves in a corresponding motion 512 within the user interface 503. The user interface 503 detects the motion and snaps the cursor to the landing zone 504-507 closest to the direction of motion, which, in the example shown in FIG. 2, is landing zone 2 505.

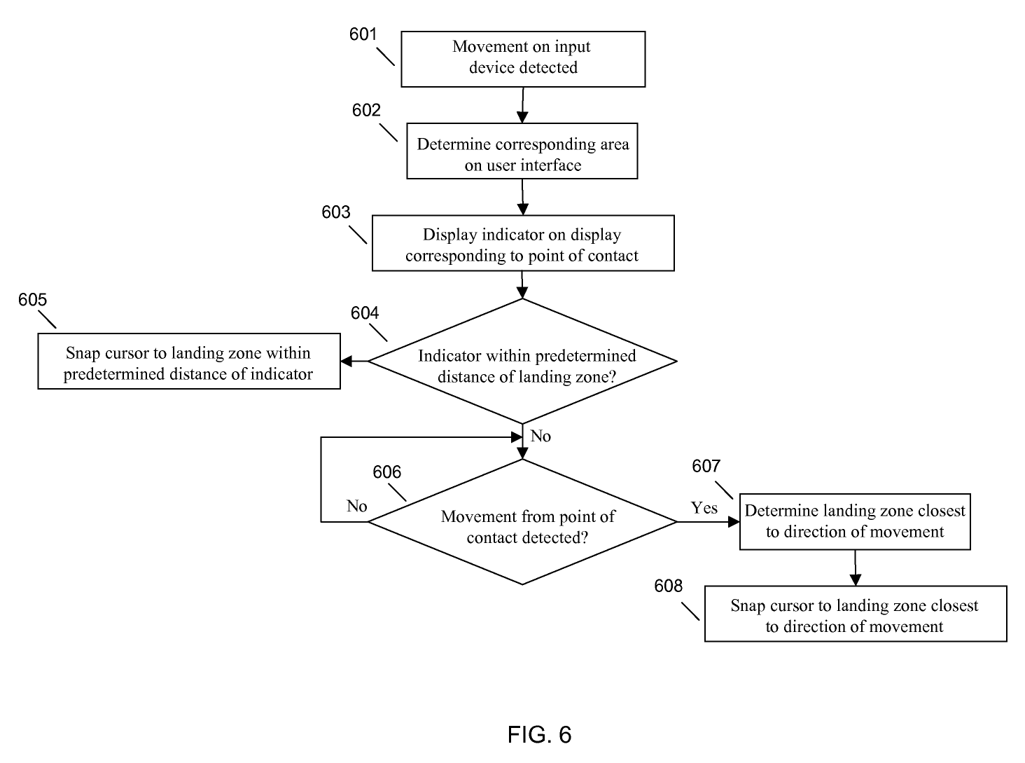

In FIG. 6 therein is provided an example snap navigation process based on area of contact on a pointing device configured according to an embodiment. The information handling device user interface detects user contact with the pointing device 601 and determines the area on the user interface corresponding to the user pointing device contact 602. An indicator appears on the user interface 603 indicating the selected area. If the indicator is within a predetermined distance of a landing zone 604, the user interface snaps the cursor to that landing zone 605. Otherwise, the indicator remains in an inactive area of the user interface until movement is detected 606 through the pointing device. When user movement is detected 606, the user interface accesses information pertaining to the location of landing zones on the user interface and determines the closest landing zone in the direction of the user movement on the pointing device 607. The user interface snaps the cursor to the closest landing zone in the direction of user movement 608.

Certain user interfaces, such as operating system interfaces with multiple icons or application interfaces with a number of menus, may be difficult to operate using a touchscreen or an emulated touchscreen as described herein. A major issue is unintended selections, such as the simultaneous selection of multiple items or the selection of a wrong icon between two closely located icons. According to embodiments, certain selected areas of the screen may be magnified, such as the user interface indicator or the area of a selected icon. In another embodiment, if a user makes an accompanying gesture, such as contacting a touchpad with a second finger, touchpad movement may move the landing zone within the user interface.

According to an embodiment, a pointing device may operate based on the particular device ecosystem. For example, if a conventional (e.g., WIMP (Windows, Icons, Menu, Pointing device)) operating system or application is active on an information handling device, the pointing device may operate according to conventional methods. Responsive to detection or activation of an ultra-mobile ecosystem interface (e.g., MPG (Multi-touch, Physics, Gestures)), the pointing device may operate according to embodiments described herein. According to embodiments, a user interface may switch between operational modes based on, inter alia, connected input devices, active user experience, user preference, or some combination thereof. An illustrative and non-restrictive example provides for changing operational modes based on selection of an icon or other such indicator, such as pressing and holding on the pointing device for a predetermined amount of time.

Information handling devices often consist of more than one input device, such as a mouse and keyboard, or a mouse, keyboard, touchpad, and emulated versions thereof. Snap navigation configured according to embodiments may operate in conjunction with multiple input devices. A non-limiting example provides that a user may select a landing zone with a mouse and then perform snap navigation between landing zones using a touchpad according to embodiments provided herein. In another non-limiting example, a user may move between landing zones using the “Tab” key on a keyboard according to conventional keyboard navigation, and may subsequently initiate snap navigation using the touchpad at the point that keyboard navigation left off.

Embodiments provide a user experience for efficiently interacting with an information handling device environment optimized for ultra-mobile ecosystem operation through one or more conventional computing devices and/or conventional input/output devices. Accordingly, a user may interact with an application developed for an ultra-mobile device using a conventional computing device or an ultra-mobile device operably connected to conventional input/output devices.

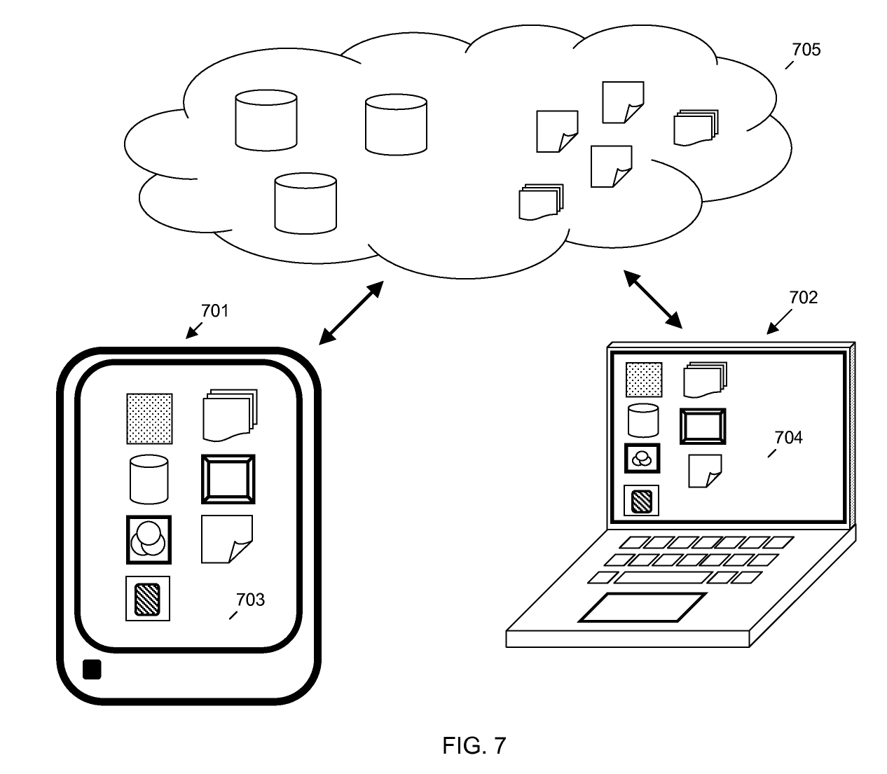

Referring now to FIG. 7, therein is provided an example cloud computing configuration utilizing information handling devices configured according to embodiments provided herein. In FIG. 7, therein is provided an ultra-mobile information handling device 701 in the form of a smartphone and a conventional information handling device in the form of a laptop computer 702. Both devices 701, 702 are executing an ultra-mobile ecosystem 703, 704 and are operably connected to a cloud computing environment 705 storing data and files. As such, a user may interact with an ultra-mobile ecosystem application using an ultra-mobile device 701 and store data and files in the cloud computing environment 705. The same user may operate the same ultra-mobile ecosystem application using the conventional computing device 702 operating according to embodiments provided herein and access the data and files stored in the cloud computing environment 705. As such, according to embodiments, a user may transition between different devices and form factors without experiencing a significant decrease in efficiency and without having to change applications and file formats.

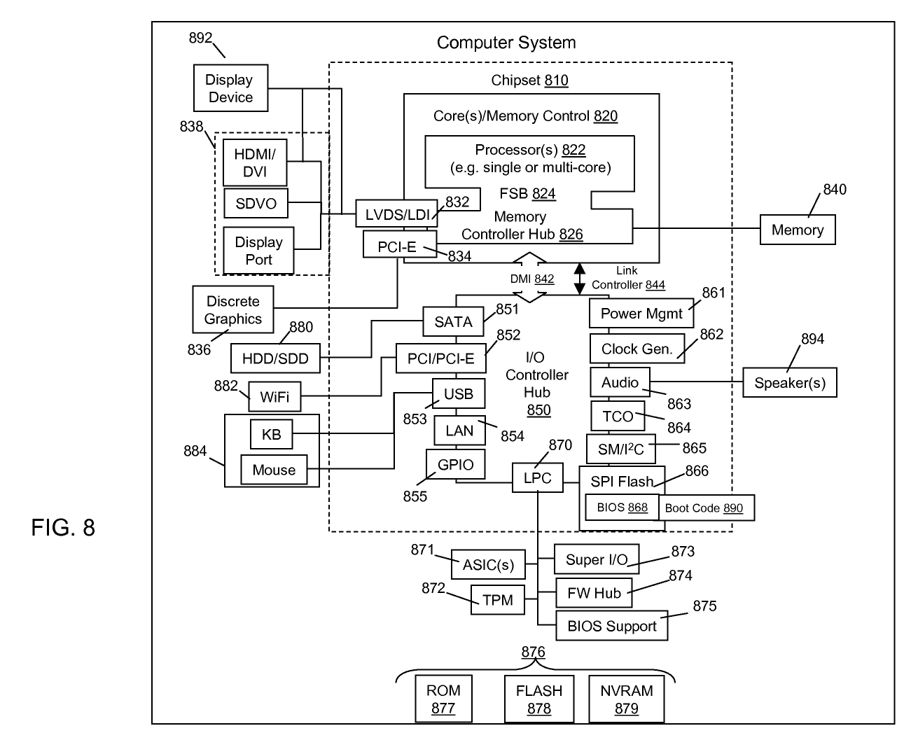

While various other circuits, circuitry or components may be utilized, FIG. 8 depicts a block diagram of one example of information handling device circuits, circuitry or components. The example depicted in FIG. 8 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 8.

The example of FIG. 8 includes a so-called chipset 810 (a group of integrated circuits, or chips, that work together, chipsets) with an architecture that may vary depending on manufacturer (for example, INTEL, AMD, ARM, etc.). The architecture of the chipset 810 includes a core and memory control group 820 and an I/O controller hub 850 that exchanges information (for example, data, signals, commands, et cetera) via a direct management interface (DMI) 842 or a link controller 844. In FIG. 8, the DMI 842 is a chip-to-chip interface (sometimes referred to as being a link between a “northbridge” and a “southbridge”). The core and memory control group 820 include one or more processors 822 (for example, single or multi-core) and a memory controller hub 826 that exchange information via a front side bus (FSB) 824; noting that components of the group 820 may be integrated in a chip that supplants the conventional “northbridge” style architecture.

In FIG. 8, the memory controller hub 826 interfaces with memory 840 (for example, to provide support for a type of RAM that may be referred to as “system memory” or “memory”). The memory controller hub 826 further includes a LVDS interface 832 for a display device 892 (for example, a CRT, a flat panel, a projector, et cetera). A block 838 includes some technologies that may be supported via the LVDS interface 832 (for example, serial digital video, HDMI/DVI, display port). The memory controller hub 826 also includes a PCI-express interface (PCI-E) 834 that may support discrete graphics 836.

In FIG. 8, the I/O hub controller 850 includes a SATA interface 851 (for example, for HDDs, SDDs, 880 et cetera), a PCI-E interface 852 (for example, for wireless connections 882), a USB interface 853 (for example, for input devices 884 such as a digitizer, keyboard, mice, cameras, phones, storage, other connected devices, et cetera.), a network interface 854 (for example, LAN), a GPIO interface 855, a LPC interface 870 (for ASICs 871, a TPM 872, a super I/O 873, a firmware hub 874, BIOS support 875 as well as various types of memory 876 such as ROM 877, Flash 878, and NVRAM 879), a power management interface 861, a clock generator interface 862, an audio interface 863 (for example, for speakers 894), a TCO interface 864, a system management bus interface 865, and SPI Flash 866, which can include BIOS 868 and boot code 890. The I/O hub controller 850 may include gigabit Ethernet support.

The system, upon power on, may be configured to execute boot code 890 for the BIOS 868, as stored within the SPI Flash 866, and thereafter processes data under the control of one or more operating systems and application software (for example, stored in system memory 840). An operating system may be stored in any of a variety of locations and accessed, for example, according to instructions of the BIOS 868. As described herein, a device may include fewer or more features than shown in the system of FIG. 8.

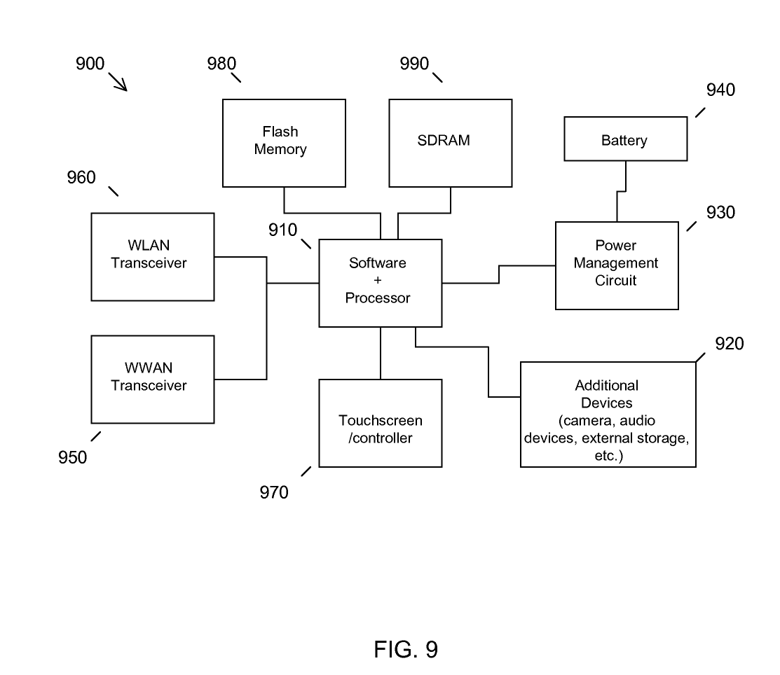

For example, referring to FIG. 9, with regard to smartphone and/or tablet circuitry 900, an example includes INTEL, AMD, and ARM based systems (systems on a chip [SoC]) design, with software and processor(s) combined in a single chip 910. Internal busses and the like depend on different vendors, but essentially all the peripheral devices (920) may attach to a single chip 910. In contrast to the circuitry illustrated in FIG. 9, the tablet circuitry 900 combines the processor, memory control, and I/O controller hub all into a single chip 910. Also, INTEL, AMD, and ARM SoC based systems 900 do not typically use SATA or PCI or LPC. Common interfaces for example include SDIO and I2C. There are power management chip(s) 930, which manage power as supplied for example via a rechargeable battery 940, which may be recharged by a connection to a power source (not shown), and in the at least one design, a single chip, such as 910, is used to supply BIOS like functionality and DRAM memory.

INTEL, AMD, and ARM SoC based systems 900 typically include one or more of a WWAN transceiver 950 and a WLAN transceiver 960 for connecting to various networks, such as telecommunications networks and wireless base stations. Commonly, an INTEL, AMD, and ARM SoC based system 900 will include a touchscreen 970 for data input and display. INTEL, AMD, and ARM SoC based systems 900 also typically include various memory devices, for example flash memory 980 and SDRAM 990.

Embodiments may be implemented in one or more information handling devices configured appropriately to execute program instructions consistent with the functionality of the embodiments as described herein. In this regard, FIGS. 8-9 illustrate non-limiting examples of such devices and components thereof. While mobile information handling devices such as tablet computers, laptop computers, and smartphones have been specifically mentioned as examples herein, embodiments may be implemented using other systems or devices as appropriate.

As will be appreciated by one skilled in the art, various aspects may be embodied as a system, method or computer (device) program product. Accordingly, aspects may take the form of an entirely hardware embodiment or an embodiment including software that may all generally be referred to herein as a “circuit,” “module” or “system.” Furthermore, aspects may take the form of a computer (device) program product embodied in one or more computer (device) readable medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An information handling device comprising:
one or more processors;
a memory storing program instructions accessible by the one or more processors;
a display device accessible by the one or more processors;
wherein, responsive to execution of the program instructions accessible by the one or more processors, the one or more processors are configured to:
execute an ultra-mobile user interface displayed on the display device, the ultra-mobile user interface being comprised of one or more landing zones;
ascertain a user selected position within the ultra-mobile user interface based on user input communicated through one or more input devices operatively coupled with the information handling device; and
select one of the one or more landing zones determined to be in closest proximity to the user selected position.

2. The information handling device according to claim 1, wherein the ultra-mobile user interface comprises a user interface optimized for an ultra-mobile information handling device having finger touch screen input.

3. The information handling device according to claim 2, wherein the information handling device comprises a conventional computing device form factor.

4. The information handling device according to claim 2, wherein the information handling device comprises an ultra-mobile information handling device comprising an emulated conventional input device.

5. The information handling device according to claim 1, wherein the one or more input devices comprise a mouse input device.

6. The information handling device according to claim 1, wherein the one or more input devices comprise a touchpad input device.

7. The information handling device according to claim 1, further comprising:
determining a direction of movement of user input communicated through the one or more input devices; and
selecting another of the one or more landing zones in the direction of movement of user input.

8. The information handling device according to claim 7, further comprising determining one of the one or more landing zones which is a closest object in the direction of movement of user input based on a straight line approximation.

9. The information handling device according to claim 1, further comprising activating a selected landing zone responsive to detecting removal of user input from the one or more input devices.

10. The information handling device according to claim 1, further comprising mapping the one or more input devices to the ultra-mobile user interface.

11. The information handling device according to claim 10, further comprising displaying an indicator on the display device responsive to detecting user input on the one or more input devices, the indicator being configured to indicate an area of the ultra-mobile user interface corresponding to a location of the user input on the one or more input devices.

12. A method comprising:
executing an ultra-mobile user interface displayed on a display device accessible by an information handling device, the ultra-mobile user interface being comprised of one or more landing zones;
ascertaining a user selected position within the ultra-mobile user interface based on user input communicated through one or more input devices operatively coupled with the information handling device; and
selecting one of the one or more landing zones determined to be in closest proximity to the user selected position.

13. The method according to claim 12, wherein the ultra-mobile user interface comprises a user interface optimized for an ultra-mobile information handling device having finger touch screen input.

14. The method according to claim 12, wherein the information handling device comprises a conventional computing device form factor.

15. The method according to claim 12, wherein the information handling device comprises an ultra-mobile information handling device comprising an emulated conventional input device.

16. The method according to claim 12, wherein the one or more input devices comprise a mouse input device.

17. The method according to claim 12, wherein the one or more input devices comprise a touchpad input device.

18. The method according to claim 12, further comprising:
determining a direction of movement of user input communicated through the one or more input devices; and
selecting another of the one or more landing zones in the direction of movement of user input.

19. The method according to claim 18, further comprising determining one of the one or more landing zones which is a closest object in the direction of movement of user input based on a straight line approximation.

20. The method according to claim 12, further comprising activating a selected landing zone responsive to detecting removal of user input from the one or more input devices.

21. The method according to claim 12, further comprising mapping the one or more input devices to the ultra-mobile user interface.

22. The method according to claim 21, further comprising displaying an indicator on the display device responsive to detecting user input on the one or more input devices, the indicator being configured to indicate an area of the ultra-mobile user interface corresponding to a location of the user input on the touchpad input device.

23. A program product comprising:
a storage medium having program code embodied therewith, the program code comprising:
program code configured to execute an ultra-mobile user interface displayed on a display device accessible by an information handling device, the ultra-mobile user interface being comprised of one or more landing zones;
program code configured to ascertain a user selected position within the ultra-mobile user interface based on user input communicated through one or more input devices operatively coupled with the information handling device; and
program code configured to select one of the one or more landing zones determined to be in closest proximity to the user selected position.
